(19) United States
(12) Patent Application Publication
(10) Pub. No.: US 2024/0163913 A1
(43) Pub. Date: May 16, 2024

(54) SIGNAL-TO-INTERFERENCE PLUS NOISE RATIO (SINR)-AWARE SPATIAL REUSE

(71) Applicant: MAXLINEAR, INC., Carlsbad, CA (US)

(72) Inventors: Sigurd Schelstraete, Menlo Park, CA (US); Marcos Martínez Vázquez, Barcelona (ES)

(73) Assignee: MAXLINEAR, INC., Carlsbad, CA (US)

(21) Appl. No.: 18/506,949

(22) Filed: Nov. 10, 2023

Related U.S. Application Data
(60) Provisional application No. 63/383,251, filed on Nov. 10, 2022.

(51) Int. Cl. H04W 72/541; H04B 17/336; H04W 52/14

(52) U.S. Cl. CPC H04W 72/541; H04B 17/336; H04W 52/146

(57) ABSTRACT

A system for wireless communication may include data processing hardware and memory hardware in communication with the data processing hardware. The memory hardware may store instructions that, when executed on the data processing hardware, cause the data processing hardware to perform operations including: receiving, at a second access point (AP) from a first AP, an identity of a first receiving station (STA) and a first predicted signal-to-interference-plus-noise ratio (SINR) at the first STA, wherein the first STA is operable to receive a transmission from the first AP and the first predicted SINR is computed when the second AP begins transmitting; computing, at the second AP, a second predicted SINR at a second STA when the first AP begins transmitting; computing, at the second AP, a first transmit power back-off based on the first predicted SINR and the second predicted SINR.

### RELATED APPLICATION

This application claims the benefit of U.S. Provisional Application No. 63/383,251, filed Nov. 10, 2022, the disclosure of which is incorporated herein by reference in its entirety.

The examples discussed in the present disclosure are related to spatial reuse in wireless communication, and more specifically, to signal-to-interference plus noise ratio (SINR)-aware spatial reuse (SR).

### BACKGROUND

Unless otherwise indicated herein, the materials described herein are not prior art to the claims in the present application and are not admitted to be prior art by inclusion in this section.

Wi-Fi® communications may be configured to occur in multiple frequency bands, including the 2.4 gigahertz (GHz), 5 GHz, and 6 GHz frequency bands. Some Wi-Fi® communications may be configured to communicate using the same or similar frequencies as other Wi-Fi® communications. In some circumstances, interference between different Wi-Fi® communications may occur.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

A system for wireless communication may include data processing hardware; and memory hardware in communication with the data processing hardware. The memory hardware may store instructions that when executed on the data processing hardware may cause the data processing hardware to perform operations. The operations may include receiving, at a second access point (AP) from a first AP, an identity of a first receiving station (STA) and a first predicted signal-to-interference-plus-noise ratio (SINR) at the first STA. The first STA may be operable to receive a transmission from the first AP and the first predicted SINR may be computed when the second AP begins transmitting. The operations may include computing, at the second AP, a second predicted SINR at a second STA when the first AP begins transmitting. The operations may include computing, at the second AP, a first transmit power back-off based on the first predicted SINR and the second predicted SINR. The operations may include determining, at the second AP, one or more transmission parameters based on the first transmit power back-off.

A method for spatial reuse may include identifying, at a first access point (AP), a training transmission time. The first AP may be operable to transmit a first training transmission during the training transmission time and a second AP may be operable to transmit a second training transmission during the training transmission time. The method may include computing, at a first AP during the training transmission time, a first signal-to-interference-plus noise ratio (SINR) between the first AP and a first receiving station (STA). The method may include receiving, at a first AP from the second AP, a second SINR between the second AP and a second receiving STA. The method may include computing, at the first AP, a first transmit power back-off. The method may include receiving, at the first AP from the second AP, a second transmit power back-off. The method may include computing, at the first AP, one or more first transmission parameters based on the first transmit power back-off and the second transmit power back-off.

A system for wireless communication may include data processing hardware; and memory hardware in communication with the data processing hardware. The memory hardware may store instructions that when executed on the data processing hardware may cause the data processing hardware to perform operations. The operations may include receiving, at a second access point (AP) from a first AP, an identity of a first receiving station (STA) operable to receive a transmission from the first AP and a predicted signal-to-noise ratio (SNR) at the first STA. The operations may include computing, at the second AP, a first predicted signal-to-interference-plus-noise ratio (SINR) at the first STA when the second AP begins transmitting. The operations may include computing, at the second AP, a transmit power back-off based on the predicted SNR and the first predicted SINR.

The objects and advantages of the embodiments will be realized and achieved at least by the elements, features, and combinations particularly pointed out in the claims.

Both the foregoing general description and the following detailed description are given as examples, are explanatory, and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example of overlapping basic service set (OBSS) packet detect (PD) spatial reuse.

FIG. 2 illustrates an example of a first OBSS including a first access point (AP) and a first station (STA) and a second OBSS including a second AP and a second STA.

FIG. 3 illustrates an example of interference between a first STA and a second AP and interference between a second STA and a first AP.

FIG. 4 illustrates an example of degraded spatial reuse (SR) performance and beneficial SR performance.

FIG. 5 illustrates an example of computing transmit power back-off

FIG. 6 illustrates an example of different interferences during SR data transmission and transmission of acknowledgements (ACKs).

FIG. 7 illustrates an example of simultaneous ACK transmissions.

FIG. 8 illustrates an example training protocol sequence.

FIG. 9 illustrates an example training protocol sequence.

FIG. 10 illustrates an example protocol sequence for fully-coordinated SR.

FIG. 11 illustrates an example process flow of an access point operable to transmit using spatial reuse.

FIG. 12 illustrates an example process flow of an access point operable to transmit when another access point is using spatial reuse.

FIG. 13 illustrates an example process flow of an access point operable to transmit using spatial reuse.

FIG. 14 illustrates an example communication system configured for spatial reuse.

FIG. 15 illustrates a diagrammatic representation of a machine in the example form of a computing device within which a set of instructions, for causing the machine to perform any one or more of the methods discussed herein, may be executed.

FIG. 16 illustrates a first placement of APs and STAs and a second placement of APs and STAs.

FIG. 17 illustrates example simulation data for a spatial reuse communication system.

FIG. 18 illustrates performance results for a spatial reuse communication system.

### DESCRIPTION OF EMBODIMENTS

In electronic communications, spatial reuse may be used to increase spectral efficiency by increasing a number of parallel (i.e. simultaneous) transmissions. A basic service set (BSS) 1 and a basic service set (BSS) 2 may be overlapping BSSs. When BSS1 and BSS2 overlap, a transmitter in BSS2 may ignore clear channel assessment (CCA) thresholds when: (i) the ongoing transmission in BSS1 has a different BSS color, (ii) the detected receiving power is below a threshold amount, or (iii) the transmitter in BSS2 reduces the transmit power as prescribed by overlapping basic service set packet detect (OBSS-PD).

When the transmitter for BSS2 determines a transmit power (e.g., determines a transmit power back-off), interference at the receiver in BSS 1 may not be taken in account. In some examples, the transmit power back-off may be based on the path loss to the transmitter in BSS 1 and not the path loss to the receiver. Therefore, a spatial reuse SR transmission from the transmitter in BSS 2 may interfere with the ongoing transmission in BSS1 because the SR transmission is not designed to limit the interference to the ongoing transmission in BSS1. Consequently, the interference from the SR transmission may impair the ongoing transmission in BSS1. In addition, the ongoing transmission from the transmitter in BSS1 may interfere with the SR transmission from the transmitter in BSS2, e.g., when the transmitter in BSS2 does not select a suitable modulation and coding scheme (MCS) based on interference from the ongoing transmission in BSS2. Therefore, the ongoing transmission from the transmitter in BSS1 may impair the SR transmission in BSS2.

To enhance the SR transmission relative to ongoing transmissions, an awareness of the signal-to-noise-and-interference ratio may be used to reduce interference between the ongoing transmission in BSS1 and the SR transmission in BSS2. For OBSS-PD, mutual interference caused by concurrent transmissions (e.g., interference between the ongoing transmission in BSS1 and the SR transmission in BSS2) is not computed or known in the BSS1 and/or the BSS2. Therefore, the SR link—e.g., between the transmitter in BSS2 and the receiver in BSS2—may be degraded when the ongoing transmission interferes because the SINR is not used. Therefore, devices, systems, and methods for SINR-aware SR may be useful.

In one example, a system for wireless communication may include data processing hardware and memory hardware in communication with the data processing hardware. The memory hardware may store instructions that when executed on the data processing hardware may cause the data processing hardware to perform operations. The operations may include: receiving, at a second access point (AP) from a first AP, an identity of a first receiving station (STA) and a first predicted signal-to-interference-plus-noise ratio (SINR) at the first STA. The first STA may be operable to receive a transmission from the first AP and the first predicted SINR is computed when the second AP begins transmitting. The operations may include: computing, at the second AP, a second predicted SINR at a second STA when the first AP begins transmitting. The operations may include: computing, at the second AP, a first transmit power back-off based on the first predicted SINR and the second predicted SINR. The operations may include determining, at the second AP, one or more transmission parameters based on the first transmit power back-off

In another example, a method for spatial reuse may include identifying, at a first access point (AP), a training transmission time. The first AP may be operable to transmit a first training transmission during the training transmission time and a second AP may be operable to transmit a second training transmission during the training transmission time. The method may include computing, at a first AP during the training transmission time, a first signal-to-interference-plus noise ratio (SINR) between the first AP and a first receiving station (STA). The method may include receiving, at a first AP from the second AP, a second SINR between the second AP and a second receiving STA. The method may include computing, at the first AP, a first transmit power back-off. The method may include receiving, at the first AP from the second AP, a second transmit power back-off. The method may include computing, at the first AP, one or more first transmission parameters based on the first transmit power back-off and the second transmit power back-off.

In another example, a system for wireless communication may include data processing hardware and memory hardware in communication with the data processing hardware. The memory hardware may store instructions that when executed on the data processing hardware may cause the data processing hardware to perform operations. The operations may include one or more of: receiving, at a second access point (AP) from a first AP, an identity of a first receiving station (STA) operable to receive a transmission from the first AP and a predicted signal-to-noise ratio (SNR) at the first STA; computing, at the second AP, a first predicted signal-to-interference-plus-noise ratio (SINR) at the first STA when the second AP begins transmitting; and computing, at the second AP, a transmit power back-off based on the predicted SNR and the first predicted SINR.

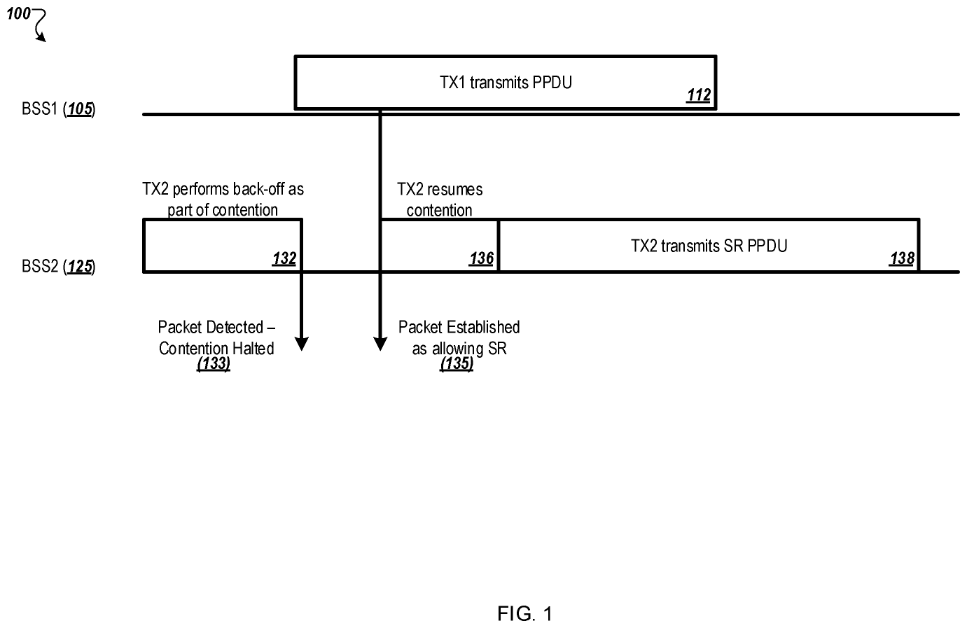

As illustrated in FIG. 1, functionality 100 for spatial reuse may include a basic service set (BSS) 1 105 that may be operable to allow transmission of a physical layer protocol data unit (PPDU) by a first transmitter (Tx1), as shown in operation 112. A second transmitter Tx2 (e.g., a station (STA)) may bypass clear channel assessment (CCA) rules when the Tx2 detects a BSS 1 PPDU (e.g., the Tx1 transmitting the PPDU in BSS 105) and the Tx2 may reduce its transmit power based on predefined rules (e.g., rules defined under Overlapping Basic Service Set (OBSS) Packet Detect (PD) spatial reuse). When applying spatial reuse (SR), the Tx2 may initialize a spatial reuse transmission opportunity “SR TXOP”.

Example functionality for OBSS_PD SR may include: (i) Tx2 performing back-off as part of contention in a BSS2 125, as shown in operation 132, (ii) and the Tx2 detecting a packet (e.g., detecting that Tx1 is transmitting PPDU), which may halt contention, as shown in operation 133. When the packet is established as allowing spatial reuse, as shown in operation 135, Tx2 may resume contention, as shown in operation 136. Tx2 may transmit an SR PPDU, as shown in operation 138.

While Tx2 may transmit an SR PPDU using rules to decrease its transmit power, the Tx2 has no knowledge of how its SR PPDU transmission affects the reception of the ongoing transmission (e.g., the Tx1 transmitting the PPDU in BSS 105). Specifically, the power back-off the SR PPDU uses may not limit interference to the first transmission (e.g., interference between Tx2 transmitting the SR PPDU and Tx1 transmitting the PPDU in BSS 105 as received by a receiver associated with Tx1). The Tx2 may adjust its Modulation and Coding Scheme (MCS) because the Tx2 is transmitting at a lower transmission power. Tx2 may not know how the ongoing transmission (e.g., the Tx1 transmitting the PPDU in BSS 105) may affect the reception of the SR PPDU even when adjusting its MCS for the change in transmit power.

When Tx1 is transmitting the PPDU in BSS1 105, Tx1 does not know when Tx2 may transmit an SR PPDU. In some cases, Tx1 may proceed based on an assumption of no interference. When Tx2 improperly selects the transmit power back-off, reception errors may occur in two different ways: (i) during the time that the PPDU transmitted in BSS1 105 overlaps with the SR PPDU, the SR PPDU may raise the interference which may cause reception errors for the PPDU transmission, or (ii) when Tx2 has adjusted its MCS based on transmit power back-off, Tx1 may interfere with the SR PPDU which may cause reception errors for the SR PPDU transmission. When the transmit power back-off is not directly related to the expected level of interference at the first receiver, the PPDU and/or the SR PPDU may be lost.

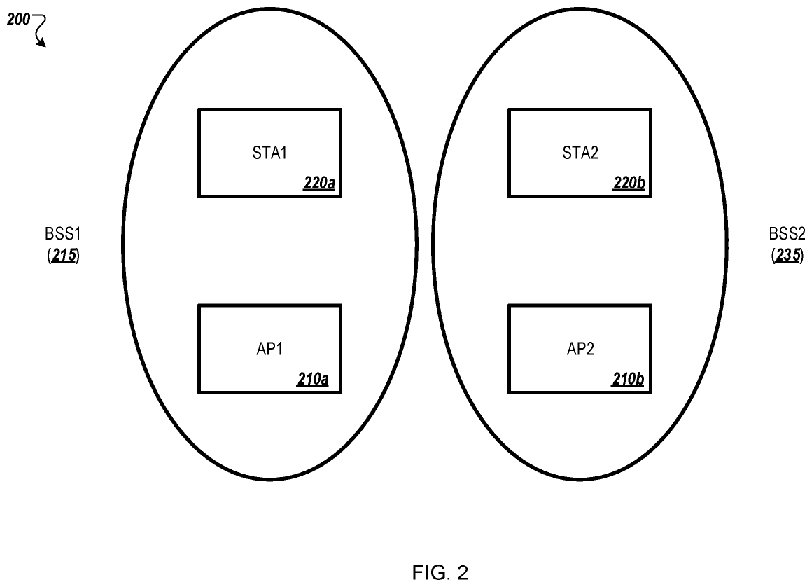

As illustrated in the communication system 200 in FIG. 2, a basic service set (BSS1) 215 may include a station 1 (STA1) 220a and an access point 1 (AP1) 210a, and a basic service set 2 (BSS2) 235 may include a STA2 220b and an access point 2 (AP2) 210b.

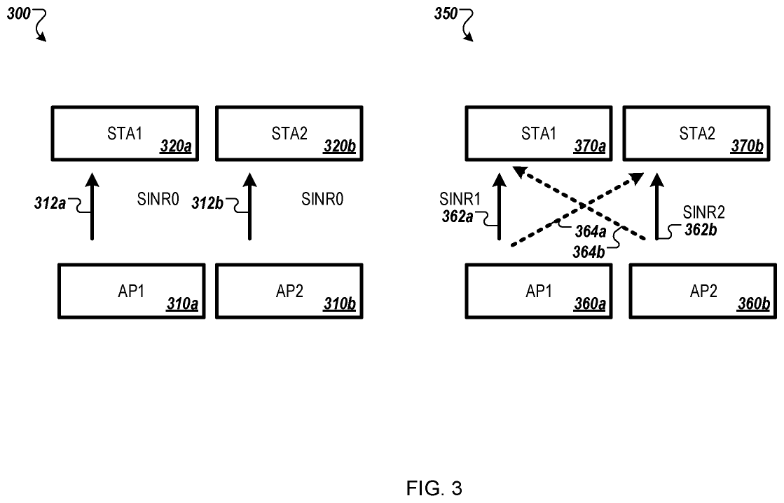

As illustrated in in the communication system 300 in FIG. 3, the signal-to-interference-plus-noise ratio (SINR) at STA1 320a when there is no interference from AP2 310b may be equal to SINR0. Likewise, the SINR at STA2 320b when there is no interference from AP1 310a may be equal to SINR0. That is, the SINR at STA1 320a may be the same as the SINR at STA2 320b when there is no interference from AP2 310b at STA1 320a and there is no interference from AP1 310a at STA2 220b.

When there is interference from AP2 310b at STA1 320a, the SINR may change from SINR0 to SINR1. Alternatively or in addition, when there is interference from AP1 310a to STA2 320b, the SINR may change from SINR0 to SINR2.

As illustrated in the communication systems 300, 350 in FIG. 3, the SINR for a BSS may change based on interference from a different BSS. In the communication system 300, AP1 310a may generate an SINR0 312a at STA1 320a and AP2 310b may generate an SINR0 312b at STA2 320b. In the communication system 350, when AP1 360a interferes with STA2 370b and AP2 360b interferes with STA1 370a, as shown by interference 364a and interference 364b, respectively, then the SINR at STA1 370a may be SINR1 362a and the SINR at STA2 370b may be SINR2 362b.

The model as illustrated in FIGS. 2 and 3 may be used to determine when SR may facilitate a beneficial increase in performance. When SR is not used, the capacity may be approximated by: Wlog₂ (1+SINR₀). When SR is not used, AP1 360a may not transmit at the same time as AP2 360b and AP2 360b may not transmit at the same time as AP1 360a. That is, AP1 360a and AP2 360b may not transmit concurrently.

When SR is used, then AP1 360a and AP2 360b may transmit concurrently. As a result, STA1 370a may encounter an SINR of SINR1 362a and STA2 370b may encounter an SINR of SINR2 362b. In this case, the capacity may be: Wlog₂(1+SINR₁)+Wlog₂(1+SINR₂).

SR may facilitate a beneficial effect on performance when the capacity with SR exceeds the capacity without SR which may be provided by log₂(1+SINR₁)+log₂(1+SINR₂)≥log₂(1+SINR₀). This inequality may be rearranged to be: (1+SINR₁)×(1+SINR₂)≥1+SINR₀ which may be approximated (when SINRi>>1) as SINR₁(dB)+SINR₂(dB)>SINR₀(dB). This criterion may be applied to determine when SR has a beneficial effect on performance.

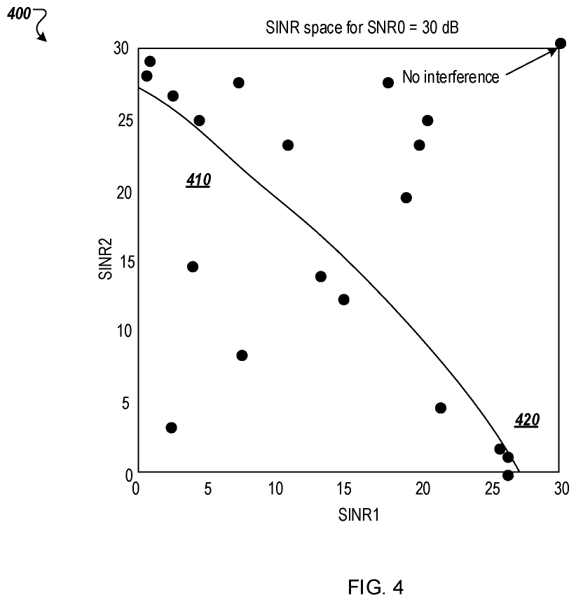

As illustrated in FIG. 4, a graph of (SINR1, SINR2) pairs 400 may be based on an SINR0 of about 30 dB. When a first receiver (e.g., STA1 370a, as illustrated in FIG. 3) or a second receiver (e.g., STA2 370b, as illustrated in FIG. 3) receive interference from a second access point (e.g., AP2 360b, as illustrated in FIG. 3) or a first access point (e.g., AP1 360a, as illustrated in FIG. 3), respectively, then SINR1 or SINR2 may be any value less than or equal to 30 dB. The pairs of (SINR1, SINR2) correspond to a point in the graph of (SINR1, SINR2) pairs 400. The region 410 may correspond to the SINR values for which using SR would degrade the performance when compared to the non-SR case. The region shown in 420 may correspond to the values for which using SR would benefit the performance when compared to the non-SR case.

Because there may be cases in which SR may be avoided to prevent the degradation of performance when compared to the non-SR case, a second access point operable for SR may avoid SR PPDU transmission to a second station when SR PPDU transmission to the second station may interfere with PPDU transmission from a first access point to a first station—or when the SR transmission would be impaired by interference caused by the ongoing transmission. To facilitate transmission avoidance under these circumstances, the impact of mutual SINR may be determined and the identity of the receivers may be determined.

When a first transmitter (e.g., AP1 360a) and a second transmitter (e.g., AP2 360b) may identify concurrent transmission, the expected capacity may be:

$${\underbrace{W {log}_{2} ( 1 + {SINR}_{1} )}}_{AP 1 \to STA 1} + {\underbrace{W {log}_{2} ( 1 + {SINR}_{2} )}}_{AP 2 \to STA 2} .$$

SR operation may not be defined based on identifying concurrent transmission. In some cases, the first transmitter (e.g., AP1 360a, as illustrated in FIG. 3) may start transmission without determining when SR is occurring and may be configured based on a modulation suitable for SNR0. In some cases, the second transmitter (e.g., AP2 360b, as illustrated in FIG. 3) may start transmission (e.g., SR transmission) after verifying OBSS PD parameters and finalizing a CW countdown. The second transmitter (e.g., AP2 360b, as illustrated in FIG. 3) may reduce its transmit power to a transmit power back-off using α=10^{α}^{_{dB}}^{/10} compared to the full-power operation for the second transmitter. The channel capacity may be approximated as:

$${\underbrace{W {log}_{2} ( 1 + α {SINR}_{1} )}}_{AP 1 \to STA 1} + {\underbrace{W {log}_{2} ( 1 + \frac{{SINR}_{2}}{α} )}}_{AP 2 \to STA 2} .$$

Using=10^{α}^{_{dB}}^{/10} to compute the transmit power back-off may rely on a number of assumptions including: (i) a power reduction of a results in a proportional decrease in interference at the first receiver (e.g., STA1 370a, as illustrated in FIG. 3) such that SINR₁ increases with α_{dB}), (ii) the power reduction of α results in a proportional decrease in SINR₂, and (iii) the first transmission (e.g., the PPDU transmission) and the second transmission (e.g., the SR PPDU transmission) overlap.

These assumptions may not facilitate optimal performance. The modulation used by the first transmitter (e.g., AP1 360a, as illustrated in FIG. 3) at the start of the first transmission, when no interference may be present, may not be optimal when the second transmitter (e.g., AP2 360b, as illustrated in FIG. 3) starts transmitting. Specifically, when αSINR₁<SNR₀, the packet error rate (PER) of the transmitted frames from the first transmitter (e.g., AP1 360a, as illustrated in FIG. 3) to the first receiver (e.g., STA1 370a, as illustrated in FIG. 3) may be higher than expected when compared to a baseline scenario in which the second transmitter does not transmit. The transmit power back-off α may be determined at the level at which the first transmitter (e.g., AP1 360a, as illustrated in FIG. 3) and the second transmitter (e.g., AP2 360b, as illustrated in FIG. 3) may interfere with one another. Basing the transmit power back-off a using the interference level between the first transmitter (e.g., AP1 360a, as illustrated in FIG. 3) and the second transmitter (e.g., AP2 360b, as illustrated in FIG. 3) may not facilitate the computation of an SINR suitable for the MCS that the first transmitter (e.g., AP1 360a, as illustrated in FIG. 3) has selected. To optimize the use of SR, the SINR at the receivers (e.g., STA1 370a and STA2 370b, as illustrated in FIG. 3) may be determined and the identity of the receivers may be determined.

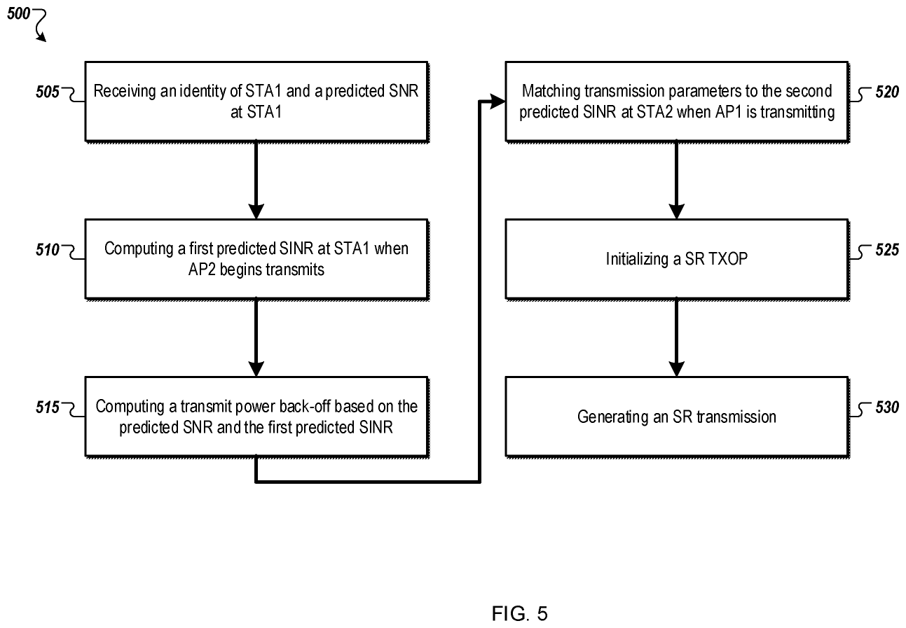

As illustrated in FIG. 5, a process flow for spatial reuse 500 may include data processing hardware and memory hardware in communication with the data processing hardware. The memory hardware may store instructions that, when executed on the data processing hardware, may cause the data processing hardware to perform operations. The operations may include one or more of: (i) receiving (e.g., at AP2 from AP1) an identity of a STA1 and a predicted signal-to-noise ratio (SNR) at STA1, as shown by operation 505; (ii) computing (e.g., at AP2) a first predicted signal-to-interference-plus-noise ratio (SINR) at STA1 when AP2 begins transmitting, as shown in operation 510, or (iii) computing (e.g., at AP2) a transmit power back-off based on the predicted SNR and the first predicted SINR, as shown in operation 515.

For the process flow for spatial reuse 500, AP2 may be operable to avoid interference when accessing the medium. AP1 may not adjust its transmission in response to AP2. AP2 may select an MCS that may be suitable for the SR PPDU transmission to STA2.

To allow for the measurement of SNR and/or SINR, a training phase may be used in which AP1 and/or AP2 may determine and/or receive the SNR and/or SINR at the various receivers (e.g., STA1 and/or STA2) when AP1 and AP2 are transmitting at the same time. AP1 may access the medium and transmit PPDU without SR restrictions. In the example, AP1 may transmit with an MCS suitable for SNR₀. The transmission may include information about the intended receiver (e.g., STA1). This information (e.g., the SNR and/or SINR at the STA1 and/or the identity of STA1) may be received by other devices (e.g., AP2).

The second transmitter (e.g., AP2) may use the information about the intended receiver (e.g., STA1) and the received and/or computed information about the effect of the second transmitter's (e.g., AP2) on the intended receiver (e.g., STA1) for spatial reuse transmission. The second transmitter (e.g., AP2) may determine that the SINR at the first receiver (e.g., STA1) may be SINRi when the second transmitter (e.g., AP2) starts transmitting SR PPDU. The second transmitter may compute the transmit power back-off based on a ratio between the predicted SNR and the first predicted SINR (e.g., using:

$$α = \frac{{SNR}_{0}}{{SINR}_{1}} )$$

which may maintain the SINR of the first link (e.g., the transmission link between the first transmitter, e.g., AP1, and the first receiver, e.g., STA1) at SNR₀. This computation of the transmit power back-off α may vary from the transmit power back-off computed when one or more of the SINR and/or SNR is not determined at the first receiver (e.g., STA1) or is not determined when the second transmitter (AP2) is transmitting.

The second transmitter (e.g., AP2) may include the operation: matching transmission parameters (e.g., MCS, transmit power, bandwidth, or the like) to the second predicted SINR at the second receiver (e.g., STA2) when the first transmitter (e.g., AP1) is transmitting, as shown in operation 520. The second transmitter (e.g., AP2) may determine the one or more transmission parameters based on the identity of second receiver and by determining the SINR (e.g., SINR2) when the first transmitter (e.g., AP1) is transmitting. The one or more transmission parameters may include one or more of a modulation and coding scheme, a transmission (Tx) power, a bandwidth, or the like.

The second transmitter (e.g., AP2) may include the operation initializing a spatial reuse transmission opportunity (SR TXOP), as shown in operation 525. The second transmitter (e.g., AP2) may include the operation generating a spatial reuse transmission, as shown in operation 530, for transmission to the second receiver (e.g., STA2).

Alternatively or in addition, the second transmitter (e.g., AP2) may be operable to compute a path loss between the second transmitter (e.g., AP2) and the first receiver (e.g., STA1) to determine the transmit power back-off. The second transmitter (e.g., AP2) may be operable to compute the transmit power back-off based on the path loss. In this case, the transmit power back-off may be computed without computing one or more of SNR and/or SINR at the first receiver (e.g., STA1).

The second transmitter (e.g., AP2) may measure the path loss between the second transmitter (e.g., AP2) and the first receiver (e.g., STA1) by using a control frame, sent by the first receiver (e.g., STA1) to the first transmitter (e.g., API), which may be received by the second transmitter (e.g., AP2) to allow for the measurement of the path loss from the first receiver (e.g., STA1) to the second transmitter (e.g., AP2) (e.g., AP2-STA1 path loss) which may be used to approximate the path loss from the second transmitter (e.g., AP2) to the first receiver (e.g., STA) (e.g.,STA1-AP2 path loss). Measuring the path loss may not provide the second transmitter (e.g., AP2) with a measurement of interference (e.g., SINR) at the second receiver (e.g., STA2).

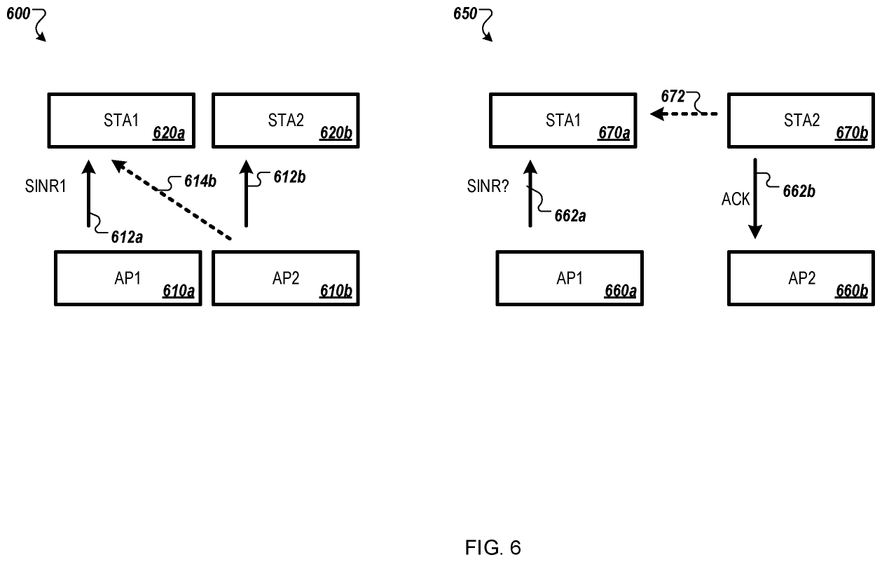

As illustrated in FIG. 6, a system for spatial reuse 600, 650 may include data processing hardware and memory hardware in communication with the data processing hardware. The memory hardware may store instructions that, when executed on the data processing hardware, may cause the data processing hardware to perform operations.

The operations may include, as shown in the system for spatial reuse 600, receiving, at a second access point (AP) (e.g., AP2 610b) from a first AP (e.g., AP1 610a), an identity of a first receiving station (STA) (e.g., STA1 620a) and a first predicted signal-to-interference-plus-noise ratio (SINR) 612a at the first STA (e.g., STA1 620a), in which the first STA (e.g., STA1 620a) may be operable to receive a transmission from the first AP (e.g., AP1 610a) and the first predicted SINR may be computed when the second AP (e.g., AP2 610b) begins transmitting. The second AP (e.g., AP1 610b) may transmit a transmission 612b to the second STA (e.g., STA2 620b) which may cause interference 614b to the first STA (e.g., STA1 620a)

One or more of the first access point (e.g., AP 610a) or the second access point (e.g., AP 610b) may perform various computations associated with SINR and/or transmit power back-offs. The operations may include computing, at the second AP (e.g., AP2 610b), a second predicted SINR at a second STA (e.g., STA2 620b) when the first AP (e.g., AP1 610a) begins transmitting. The operations may include computing, at the second AP (e.g., AP2 610b), a first transmit power back-off based on one or more of the first predicted SINR and/or the second predicted SINR. The operations may include receiving, at the second AP (e.g., AP2 610b) from the first AP (e.g., AP1 610a), a second transmit power back-off. The operations may include determining, at the second AP (e.g., AP2 610b), one or more transmission parameters (e.g., MCS, transmit power, bandwidth, or the like) based on the first transmit power back-off and/or the second transmit power back-off.

One or more of the first access point (e.g., AP 610a) or the second access point (e.g., AP 610b) may receive an identity of one or more STAs (e.g., STA1 620a or STA2 620b). One or more of the first access point (e.g., AP 610a) or the second access point (e.g., AP 610b) may receive an SINR at the one or more STAs (e.g., STA1 620a or STA2 620b). The operations may include identifying, at the second AP (e.g., AP2 610b), an identity of a second STA (e.g., STA2 620b) and a second predicted SINR at the second STA (e.g., STA2 620b). The second STA (e.g., STA2 620b) may be operable to receive a transmission from the second AP (e.g., AP2 610b). The operations may include sending, from the second AP (e.g., AP2 610b) to the first AP (e.g., AP1 610a), the identity of the second STA (e.g., STA2 620b) and the second predicted SINR.

Various transmission parameters may be determined at one or more of the first AP or the second AP. The operations may include determining, at the second AP (e.g., AP2 610b), the one or more transmission parameters based on a weighted average of the first predicted SINR and the second predicted SINR. The transmission parameters may include one or more of modulation and coding scheme (MCS), a transmission (Tx) power, bandwidth, or the like.

The second access point (e.g., AP2 610b) may be operable to send an SR PPDU. The operations may include initializing, at the second AP (e.g., AP2 610b), a spatial reuse transmission opportunity (SR TXOP), and/or generating, at the second AP (e.g., AP2 610b), a spatial reuse (SR) transmission for transmission to the second STA (e.g., STA2 620b).

The first access point (e.g., AP1 610a) may be operable for PPDU transmission when the second access point (e.g., AP2 610b) is transmitting an SR PPDU transmission. The operations may include identifying, at a first AP (e.g., AP1 610a), a training transmission time. The first AP (e.g., AP1 610a) may be operable to transmit a first training transmission during the training transmission time and a second AP (e.g., AP2 610b) may be operable to transmit a second training transmission during the training transmission time.

The first access point (e.g., AP1 610a) may use the SINR to compute one or more transmit power back-offs or one or more first transmission parameters. The operations may include computing, at a first AP (e.g., AP1 610a) during the training transmission time, a first signal-to-interference-plus noise ratio (SINR) between the first AP (e.g., AP1 610a) and a first receiving station (STA) (e.g., STA1 620a). The operations may include receiving, at a first AP (e.g., AP1 610a) from the second AP (e.g., AP2 610b) a second SINR between the second AP (e.g., AP2 610b) and a second receiving STA (e.g., STA2 620b). The operations may include computing, at the first AP (e.g., AP1 610a), a first transmit power back-off. The operations may include receiving, at the first AP (e.g., AP1 610a) from the second AP (e.g., AP2 610b), a second transmit power back-off. The operations may include computing, at the first AP (e.g., AP1 610a), one or more first transmission parameters based on the first transmit power back-off and/or the second transmit power back-off

The first AP (e.g., AP1 610a) may compute one or more of the transmission parameters and/or the transmit power back-off in various ways. The first AP (e.g., AP 610a) may determine the one or more first transmission parameters based on a weighted average of the first SINR and the second SINR. The transmission parameters may include one or more of an MCS, a transmission (Tx) power, a bandwidth, or the like. The first AP (e.g., AP1 610a) may receive, from the second AP, one or more second transmission parameters based on the first transmit power back-off and/or the second transmit power back-off. The one or more second transmission parameters may be computed at the second AP (e.g., AP2 610b).

When the first AP (e.g., AP1 610a) has determined the one or more transmission parameters and/or the transmit power back-off, the first AP (e.g., AP1 610a) may be operable to send a PPDU to the first STA (e.g., STA1 620a). The first AP (e.g., AP1 610a) may be operable to initialize a transmission opportunity (TXOP), and generate a transmission to the first STA (e.g., STA1 620a).

The first AP (e.g., AP 610a) and/or the second AP (e.g., AP 610b) may identify that the other AP may plan on transmitting at the start of the TXOP. The first AP (e.g., AP 610a) and the second AP (e.g., AP 610b) may be operable to determine the impact on SINR for the respective links (e.g., the link between the first AP and the first STA and the link between the second AP and the second STA).

The first AP (e.g., AP 610a) and/or the second AP (e.g., AP 610b) may receive information about the identity of the respective links and/or the SINR impact on the respective links by transmitting and measuring during a training time. One or more of the first AP (e.g., AP 610a) and/or the second AP (e.g., AP 610b) may send a joint training transmission time to the other AP (e.g., the first AP may send the joint transmission time to the second AP or the second AP may send the joint transmission time to the first AP). One or more of the first AP (e.g., AP 610a) and/or the second AP (e.g., AP 610b) may send the joint training transmission time to compute a first or second predicted SINR (e.g., the first AP may send the joint transmission time to the second AP or the second AP may send the joint transmission time to the first AP). One or more of the first AP (e.g., AP 610a) and/or the second AP (e.g., AP 610b) may receive one or more of the first predicted SINR or the second predicted SINR (e.g., which may be received from one or more of the first AP (e.g., AP 610a) or the second AP (e.g., AP 610b)). That is, the access points (e.g., AP1 610a and/or AP2 620b) may receive information about the intended receiver of the active transmission and the SINR at the intended receiver when the SR transmitter (e.g., AP2 620b) starts its frame.

The training operations may include communication between the first AP (e.g., AP 610a) and the second AP (e.g., 610b) to determine a joint transmission time in which the first AP (e.g., AP1 610a) and the second AP (e.g., AP2 610b) may concurrently transmit. The joint transmission time may be communicated to the respective associated STAs (e.g., AP1 610a may communicate the joint transmission time to STA1 620a and AP2 610b may communicate the joint transmission time to STA2 620b). The first AP (e.g., AP 610a) and the second AP (e.g., 610b) may start the training transmission.

During the training transmission, one or more of the first STA and/or the second STA (e.g., STA1 620a and/or STA2 620b) may perform an SINR measurement. One or more of the first STA and/or the second STA (e.g., STA1 620a and/or STA2 620b) may communicate the SINR measurement back to the respective APs (e.g., AP1 610a for STA1 620a and/or AP2 610b for STA2 620b). One or more of the first AP (e.g., AP 610a) and/or the second AP (e.g., AP 610b) ma exchange the one or more SINR measurements to provide one or more of the first AP (e.g., AP 610a) and/or the second AP (e.g., AP 610b) with information about how an overlapping transmission affects the SINR of one or more of the first STA and/or the second STA (e.g., STA1 620a and/or STA2 620b) in the one or more OBSS.

One or more of the first AP (e.g., AP 610a) and/or the second AP (e.g., AP 610b) may determine the one or more transmission parameters. One or more of the first AP (e.g., AP 610a) and/or the second AP (e.g., AP 610b) may select an MCS that may be suitable for the expected SINR using:

$${\underbrace{W {log}_{2} ( 1 + {SINR}_{1} )}}_{AP 1 \to STA 1} + {\underbrace{W {log}_{2} ( 1 + {SINR}_{2} )}}_{AP 2 \to STA 2} .$$

In some cases, one or more of the first AP (e.g., AP 610a) and/or the second AP (e.g., AP 610b) may apply a power back-off. When the first AP (e.g., AP1 610a) selects a back-off of β and the second AP (e.g., AP2 610b) selects a back-off of α, the capacity may be approximated as:

$${\underbrace{W {log}_{2} ( 1 + \frac{α}{β} {SINR}_{1} )}}_{AP 1 \to STA 1} + {\underbrace{W {log}_{2} ( 1 + \frac{β}{α} {SINR}_{2} )}}_{AP 2 \to STA 2} .$$

In some cases, one or more of the first AP (e.g., AP 610a) and/or the second AP (e.g., AP 610b) may select α and β cooperatively to optimize the joint capacity of the systems.

Other factors may be included such as: (i) the total noise as a combination of interference and thermal noise, and/ or (ii) the SINR being limited by the receive EVM. One or more of the first AP (e.g., AP 610a) and/or the second AP (e.g., AP 610b) may determine the first transmit power back-off based on one or more of background noise or a maximum receive error vector magnitude (EVM). The background noise N₀ may be included by using:

$$W {log}_{2} ( 1 + \frac{{\vert {H}_{11} \vert}^{2} α {Tx}_{1}}{{N}_{0} + {\vert {H}_{21} \vert}^{2} β {Tx}_{2}} ) + W {log}_{2} ( 1 + \frac{{\vert {H}_{22} \vert}^{2} β {Tx}_{2}}{{N}_{0} + {\vert {H}_{12} \vert}^{2} α {Tx}_{1}} ) .$$

The receive EVM (RxEVM₁ and RxEVM₂ respectively) may be included by using:

$$W {log}_{2} ( 1 + min \frac{{\vert {H}_{11} \vert}^{2} α {Tx}_{1}}{{N}_{0} + {\vert {H}_{21} \vert}^{2} β {Tx}_{2}} , {RxEVM}_{1} ) ) + W {log}_{2} ( 1 + max ( \frac{{\vert {H}_{22} \vert}^{2} β {Tx}_{2}}{{N}_{0} + {\vert {H}_{12} \vert}^{2} α {Tx}_{1}} , {RxEVM}_{2} ) ) .$$

As illustrated in FIG. 6, as shown in the system for spatial reuse 650, interference may be different during data transmission and ACK transmission. A first access point (e.g., AP1 660a) may be operable to transmit a PPDU transmission 662a which may be received at a first station (e.g., STA1 670a) having an SINR. A second station (e.g., STA2 670b) may be operable to transmit an Ack transmission 662b which may be received at second access point (e.g., AP2 660b) and may generate interference 672 which may be received at the first station (e.g., STA1 670a).

The interference 672 caused by the ACK transmission 662b may be different when compared to the interference caused by a data transmission between the second access point (e.g., AP2 660b) and the second station (e.g., STA2 670b). That is, when the first access point (e.g., AP1 660a) and the second access point (e.g., AP2 660b) transmit at the same time, the interference experienced by the signal transmitted by e.g., the first access point (e.g., AP1 660a), may be determined by the second transmission from AP2. This value (e.g., SINR₁) may be determined using the training operations as described herein.

When the transmission from the second access point (e.g., AP2 660b) ends before the transmission of the first access point (e.g., AP1 660a) and the second station (e.g., STA2 670b) sends an ACK transmission 662b to the second access point (e.g., AP2 660b), the level of interference at the first station (e.g., STA1 670a) may change because it may be affected by the transmission by the second station (e.g., STA2 670b). This level of interference may be unknown and unrelated to the levels determined during the training operations.

The change in interference level may be prevented by terminating both transmissions (e.g., the transmission from a first AP and an SR transmission from a second AP) at the same time such that the ACK transmissions (e.g., from the first STA and the second STA) are initiated at the same time. In one example, the SR transmission may be terminated, at the second AP, to match a transmission end of a transmission from the first AP. In one example, the second ACK transmission may be initiated at the same time as the first ACK transmission to match the first ACK transmission to the second ACK transmission. The interference during the concurrent ACK transmission may be present in the system for spatial reuse without causing degradation to the data transmission from AP1 660a or the SR transmission from AP2 660b when ACK transmissions are transmitted at the same time.

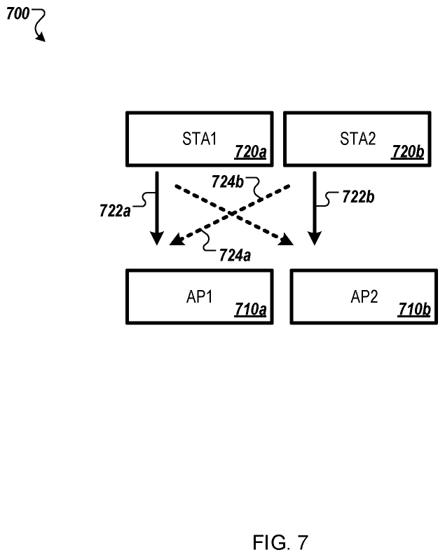

As illustrated in the system for spatial reuse 700 in FIG. 7, the first STA (e.g., STA1 720a) may send an ACK transmission 722a to the first access point (e.g., AP1 710a) and the second STA (e.g., STA2, 720b) may send an ACK transmission 722b to the second access point (e.g., AP2 710b). Interference 724b may be generated by the Ack transmission 722a from the first station (e.g., STA1 720a) and may radiate to the second access point (e.g., AP2 710b). Interference 724a may be generated by the Ack transmission 722b from the second station (e.g., STA2 720b) and may radiate to the first access point (e.g., AP1 710a). When the ACK transmissions 722a, 722b are sent at robust modulations, the mutual interference 724a, 724b during the ACK transmissions 722a, 722b may not cause a level of interference greater than an unsuitable threshold.

In some examples, when one or more of the first AP (e.g., AP 710a) and/or the second AP (e.g., AP 710b) perform contentions and/or retransmissions, various detrimental effects on performance may occur. For example, when the second STA (e.g., STA2 720b) performs SR and the transmission fails (e.g., no ACK is received), the second STA (e.g., STA2 720b) may increase its contention window (CW). The increased CW increases the probability that the back-off counter (BO) may expire while another transmission (e.g., a PPDU transmission from the first access point, e.g., AP1 710a, to the first STA, e.g., STA1 720a) may be active on the medium. As a result, the second STA (e.g., STA2 720b) may repeat SR and fail again which may generate a cycle in which the CW of the second STA (e.g., STA 720b) may increase, because of continued SR failures, and the increasing BO may further increase the probability that the next transmission will be an SR TXOP.

To increase the performance, one or more of the first AP (e.g., AP 710a) and/or the second AP (e.g., AP 710b) may identify spatial reuse transmission failure and/or terminate spatial reuse. One or more of the first AP (e.g., AP 710a) and/or the second AP (e.g., AP 710b) may perform a subsequent channel access without using spatial reuse. One or more of the first AP (e.g., AP 710a) and/or the second AP (e.g., AP 710b) may adapt a spatial reuse rate to avoid interference with a first AP (e.g., AP 710a).

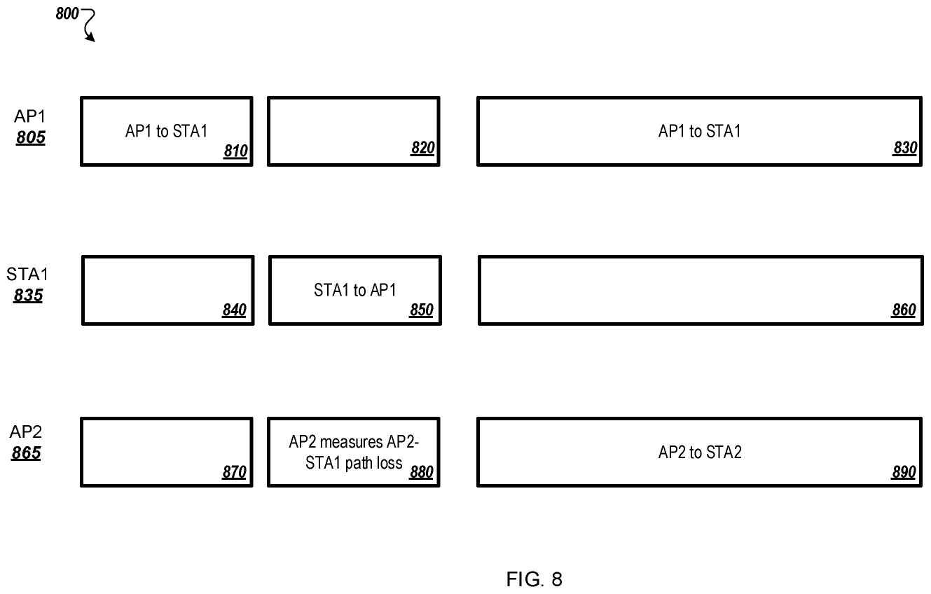

Various protocols may be used for sending PPDU and SR PPDU transmissions. As illustrated in the protocol 800 in FIG. 8, during a first time window, a first AP (e.g., AP1 805) may be operable to send a transmission to a first station (e.g., STA1 835), as shown in operation 810. During the first time window, the first station (e.g., STA1 835) and the second access point (e.g., AP2 865) may not transmit (e.g., as shown by block 840 and block 870).

During a second time window, the first station (e.g., STA1 835) may be operable to send a transmission to the first access point (e.g., AP1 805), as shown in operation 850. During the second time window, the second access point (e.g., AP2 865) may be operable to measure the path loss between the second access point (e.g., AP2 865) and the first station (e.g., STA1 835), as shown by operation 880. During the second time window, the first access point (e.g., AP1 805) may not transmit, as shown by block 820.

The second access point may measure the path loss between the second access point (e.g., AP2 865)and the first station (e.g., STA1 835) by performing one or more operations including one or more of: (i) receiving, at a second access point (AP) (e.g., AP2 865) from a first AP (e.g., AP1 805), an identity of a first receiving station (STA) (e.g., STA1 835) operable to receive a transmission from the first AP (e.g., AP1 805),(ii) computing, at the second AP (e.g., AP2 865), a path loss between the second AP (e.g., AP2 865) and the first STA (e.g., STA1 835); and (iii) computing, at the second AP (e.g., AP2 865), the transmit power back-off based on the path loss.

During the third time window, the first access point (e.g., AP1 805) may be operable to send a PPDU transmission to the first station (e.g., STA 835), as shown by operation 830. During this third time window, the second access point (e.g., AP2 865) may be operable to send an SR PPDU transmission to the second STA (e.g., STA2 (not shown)), as shown by operation 890. The second access point (e.g., AP2 865) may use the path loss between the second access point (e.g., AP2 865) and the first station (e.g., the AP2-STA1 path loss) to control the interference level at the first station (e.g., STA1 835). During the third time window, the first station (e.g., STA1 835) may not transmit, as shown by operation 860.

In some cases, the second access point (e.g., AP2 865) may not be able to measure or identify an interference level at the second station (e.g., STA2 (not shown)) in which the interference level is affected by the transmission between the first access point (e.g., AP1 805) and the first station (e.g., STA1 835).

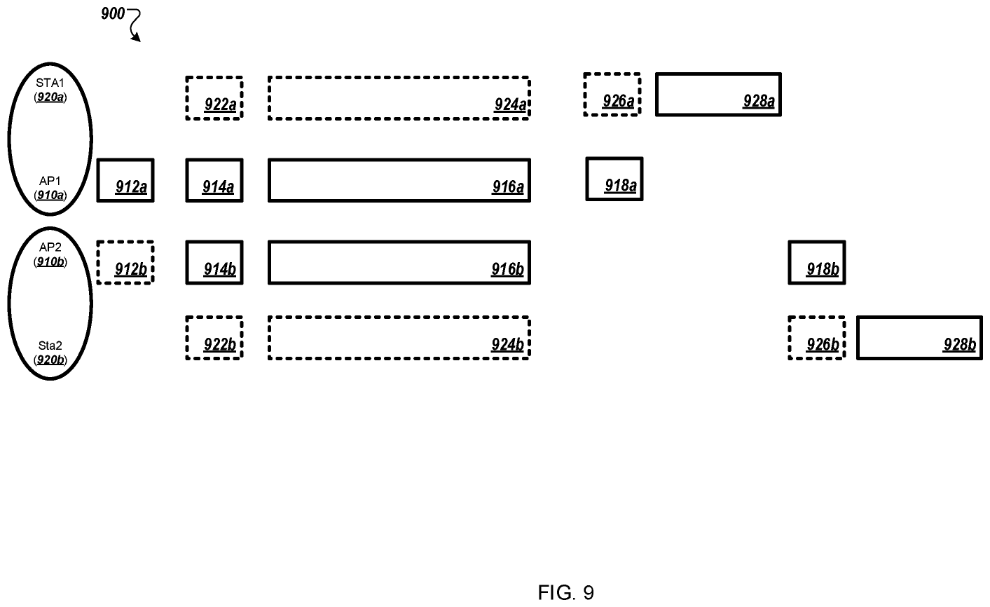

In some examples, as illustrated in FIG. 9, a protocol sequence 900 may be operable to allow for measuring the interference level at both the first station (e.g., STA1 920a) and the second station (e.g., STA2 920b) based on interference generated by one or more of the first access point (e.g., AP1 910a) or the second access point (e.g., AP2 910b). To measure the interference level at both the first station (e.g., STA1 920a) and the second station (e.g., STA2 920b), a training protocol may be used. The training protocol may include one or more operations.

The operations may include, during a first time window, a first access point (e.g., AP1 910a) that may initiate a training sequence, as shown in operation 912a (during which the second access point (e.g., 910b) may not transmit as indicated by block 912b).

The operations may include, during a second time window, that the first access point (e.g., AP 910a) and the second access point (e.g., 910b) may send concurrent training start indications, as shown by operations 914a and 914b, to respective stations (e.g., STA1 920a and STA2 920b) (during which blocks 922a and 922b show no transmission by STA1 920a and STA2 920b).

The operations may include, during a third time window, that the first access point (e.g., AP 910a), as shown by operation 916a, and the second access point (e.g., 910b), as shown by operation 916b, may send concurrent training signals and the respective STAs (e.g., STA1 920a and STA2 920b) may perform measurements. During this third time window, the respective STAs (e.g., STA1 920a and STA2 920b) may not transmit, as shown by operations 924a, 924b.

The operations may include, during a fourth time window, that the first access point (e.g., AP1 910a) request measurement results from the first station (e.g., STA1 920a), as shown by operation 918a. During this fourth time window, the first station (e.g., STA1 920a) may not transmit, as shown by operation 926a. During a fifth time window, the first station (e.g., STA1 920a) may reply with measurement results, as shown by operation 928a.

The operations may include, during a sixth time window, that the second access point (e.g., AP2 910b) request measurement results from the second station (e.g., STA2 920b), as shown by operation 918b. During this sixth time window, the second station (e.g., STA2 920b) may not transmit, as shown by operation 926b. During a seventh time window, the second station (e.g., STA2 920b) may reply with measurement results, as shown by operation 928b.

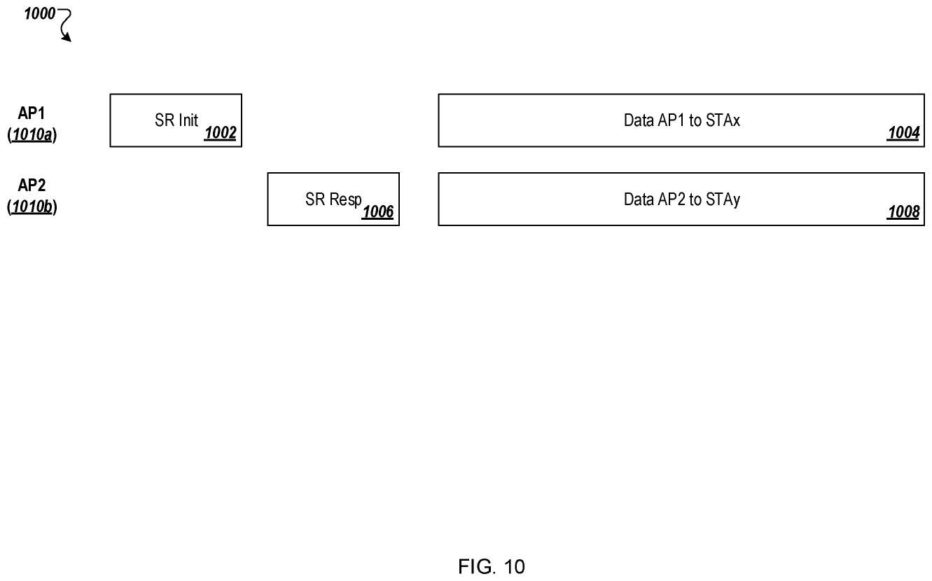

As illustrated in FIG. 10, functionality for spatial reuse 1000 may include a first access point (e.g., AP1 1010a) and a second access point (e.g., AP2 1010b). During a first time window, the first access point may be operable to initiate SR, as shown by operation 1002, by sending to the second access point (e.g., AP2 1010b) an indication that a frame is to be sent to a first station (e.g., STAx). The first access point may include additional information such as the TX-OP duration, access category (AC), or the like.

During a second time window, the second access point (e.g., AP2 1010b) may be operable to perform an SR response by sending to the first access point (e.g., AP1 1010a) an indication to send a frame to a second station (e.g., STAy) during the SR period as initiated by the first access point (e.g., API 1010a) as shown by operation 1006.

During a third time window, the first access point (e.g., API 1010a) and the second access point (e.g., AP2 1010b) may transmit concurrently by selecting an MCS for the respective transmission that may account for mutual interference (e.g., interference from the first access point (e.g., API 1010a) to the second station (e.g., STAy) and interference from the second access point (e.g., AP2 1010b) to the first station (e.g., STAx)). The first access point (e.g., API 1010a) may transmit data to the first station (e.g., STAx), as shown by operation 1004. The second access point (e.g., AP2 1010b) may transmit data to the second station (e.g., STAy), as shown by operation 1008.

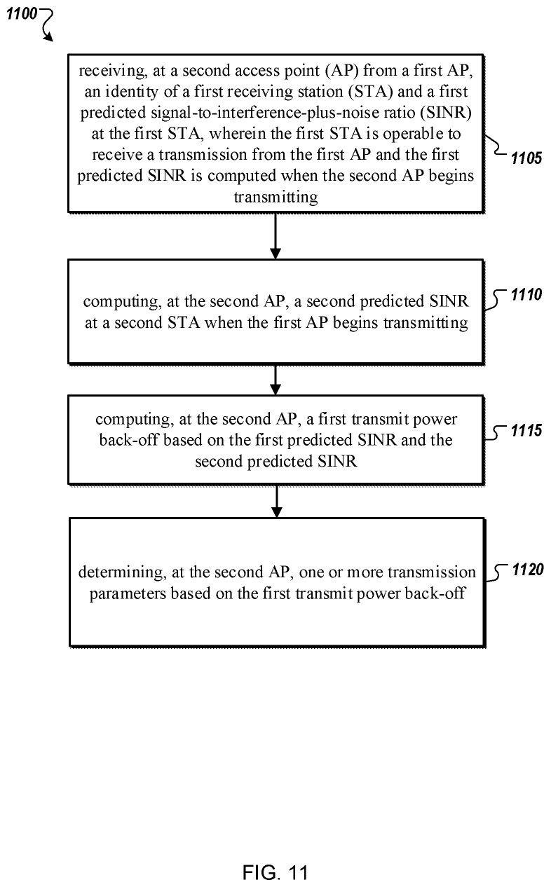

FIG. 11 illustrates a process flow of an example method 1100 of spatial reuse, in accordance with at least one example described in the present disclosure. The method 1100 may be arranged in accordance with at least one example described in the present disclosure.

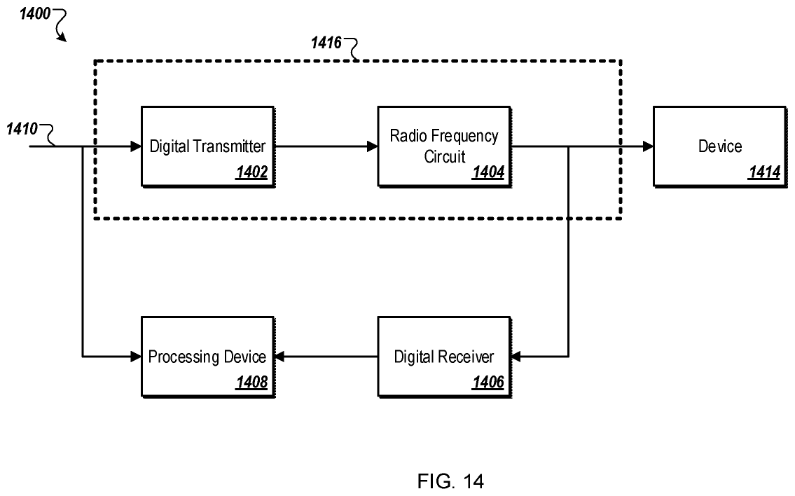

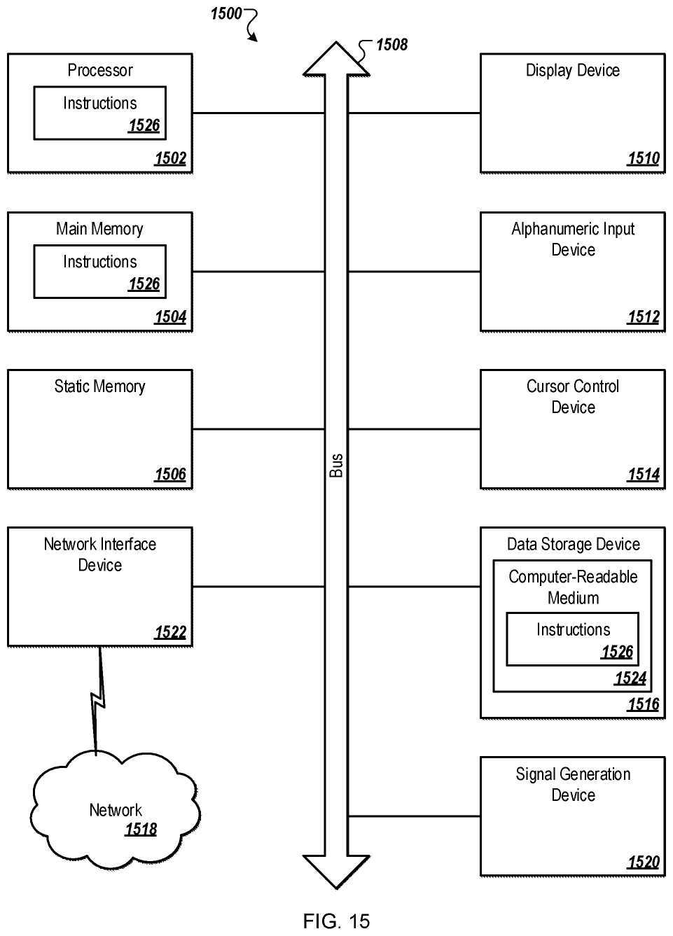

The method 1100 may be performed by processing logic that may include hardware (circuitry, dedicated logic, etc.), software (such as is run on a computer system or a dedicated machine), or a combination of both, which processing logic may be included in the processing device (e.g., processor 1502) of FIG. 15, the communication system 1400 of FIG. 14, or another device, combination of devices, or systems.

The method 1100 may begin at block 1105 where the processing logic may include receiving, at a second access point (AP) from a first AP, an identity of a first receiving station (STA) and a first predicted signal-to-interference-plus-noise ratio (SINR) at the first STA, wherein the first STA is operable to receive a transmission from the first AP and the first predicted SINR is computed when the second AP begins transmitting.

At block 1110, the processing logic may include computing, at the second AP, a second predicted SINR at a second STA when the first AP begins transmitting.

At block 1115, the processing logic may include computing, at the second AP, a first transmit power back-off based on the first predicted SINR and the second predicted SINR.

At block 1120, the processing logic may include determining, at the second AP, one or more transmission parameters based on the first transmit power back-off.

Modifications, additions, or omissions may be made to the method 1100 without departing from the scope of the present disclosure. For example, in some examples, the method 1100 may include any number of other components that may not be explicitly illustrated or described.

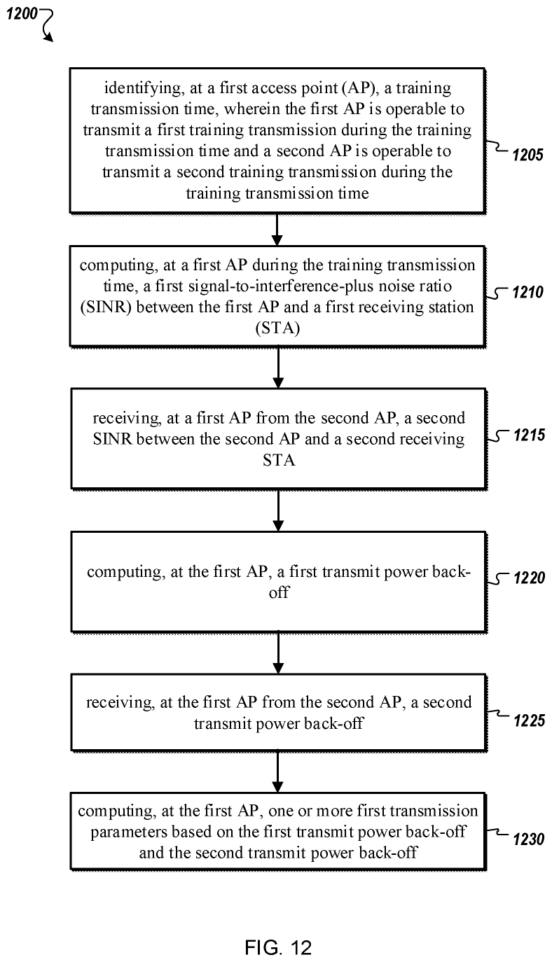

FIG. 12 illustrates a process flow of an example method 1200 that may be used for spatial reuse, in accordance with at least one example described in the present disclosure. The method 1200 may be arranged in accordance with at least one example described in the present disclosure.

The method 1200 may be performed by processing logic that may include hardware (circuitry, dedicated logic, etc.), software (such as is run on a computer system or a dedicated machine), or a combination of both, which processing logic may be included in the processing device (e.g., processor 1502) of FIG. 15, the communication system 1400 of FIG. 14, or another device, combination of devices, or systems.

The method 1200 may begin at block 1205 where the processing logic may include identifying, at a first access point (AP), a training transmission time, wherein the first AP is operable to transmit a first training transmission during the training transmission time and a second AP is operable to transmit a second training transmission during the training transmission time.

At block 1210, the processing logic may include computing, at a first AP during the training transmission time, a first signal-to-interference-plus noise ratio (SINR) between the first AP and a first receiving station (STA).

At block 1215, the processing logic may include receiving, at a first AP from the second AP, a second SINR between the second AP and a second receiving STA.

At block 1220, the processing logic may include computing, at the first AP, a first transmit power back-off.

At block 1225, the processing logic may include receiving, at the first AP from the second AP, a second transmit power back-off.

At block 1230, the processing logic may include computing, at the first AP, one or more first transmission parameters based on the first transmit power back-off and the second transmit power back-off.

Modifications, additions, or omissions may be made to the method 1200 without departing from the scope of the present disclosure. For example, in some examples, the method 1200 may include any number of other components that may not be explicitly illustrated or described.

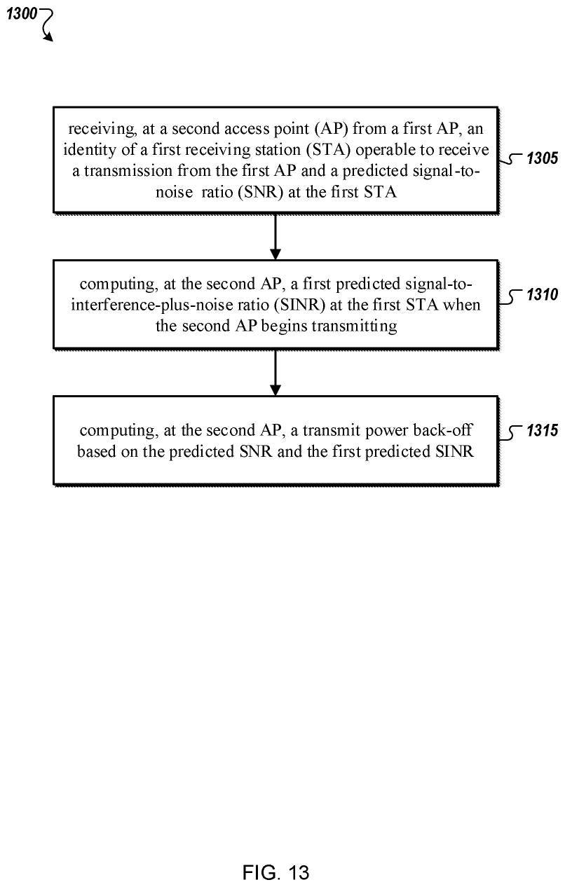

FIG. 13 illustrates a process flow of an example method 1300 that may be used for spatial reuse, in accordance with at least one example described in the present disclosure. The method 1300 may be arranged in accordance with at least one example described in the present disclosure.

The method 1300 may be performed by processing logic that may include hardware (circuitry, dedicated logic, etc.), software (such as is run on a computer system or a dedicated machine), or a combination of both, which processing logic may be included in the processing device (e.g., processor 1502) of FIG. 15, the communication system 1400 of FIG. 14, or another device, combination of devices, or systems.

The method 1300 may begin at block 1305 where the processing logic may include receiving, at a second access point (AP) from a first AP, an identity of a first receiving station (STA) operable to receive a transmission from the first AP and a predicted signal-to-noise ratio (SNR) at the first STA.

At block 1310, the processing logic may include computing, at the second AP, a first predicted signal-to-interference-plus-noise ratio (SINR) at the first STA when the second AP begins transmitting.

At block 1315, the processing logic may include computing, at the second AP, a transmit power back-off based on the predicted SNR and the first predicted SINR.

Modifications, additions, or omissions may be made to the method 1300 without departing from the scope of the present disclosure. For example, in some examples, the method 1300 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 14 illustrates a block diagram of an example communication system 1400 configured for AP interference reduction, in accordance with at least one example described in the present disclosure. The communication system 1400 may include a digital transmitter 1402, a radio frequency circuit 1404, a device 1414, a digital receiver 1406, and a processing device 1408. The digital transmitter 1402 and the processing device may be configured to receive a baseband signal via connection 1410. A transceiver 1416 may include the digital transmitter 1402 and the radio frequency circuit 1404.

In some examples, the communication system 1400 may include a system of devices that may be configured to communicate with one another via a wired or wireline connection. For example, a wired connection in the communication system 1400 may include one or more Ethernet cables, one or more fiber-optic cables, and/or other similar wired communication mediums. Alternatively, or additionally, the communication system 1400 may include a system of devices that may be configured to communicate via one or more wireless connections. For example, the communication system 1400 may include one or more devices configured to transmit and/or receive radio waves, microwaves, ultrasonic waves, optical waves, electromagnetic induction, and/or similar wireless communications. Alternatively, or additionally, the communication system 1400 may include combinations of wireless and/or wired connections. In these and other examples, the communication system 1400 may include one or more devices that may be configured to obtain a baseband signal, perform one or more operations to the baseband signal to generate a modified baseband signal, and transmit the modified baseband signal, such as to one or more loads.

In some examples, the communication system 1400 may include one or more communication channels that may communicatively couple systems and/or devices included in the communication system 1400. For example, the transceiver 1416 may be communicatively coupled to the device 1414.

In some examples, the transceiver 1416 may be configured to obtain a baseband signal. For example, as described herein, the transceiver 1416 may be configured to generate a baseband signal and/or receive a baseband signal from another device. In some examples, the transceiver 1416 may be configured to transmit the baseband signal. For example, upon obtaining the baseband signal, the transceiver 1416 may be configured to transmit the baseband signal to a separate device, such as the device 1414. Alternatively, or additionally, the transceiver 1416 may be configured to modify, condition, and/or transform the baseband signal in advance of transmitting the baseband signal. For example, the transceiver 1416 may include a quadrature up-converter and/or a digital to analog converter (DAC) that may be configured to modify the baseband signal. Alternatively, or additionally, the transceiver 1416 may include a direct radio frequency (RF) sampling converter that may be configured to modify the baseband signal.

In some examples, the digital transmitter 1402 may be configured to obtain a baseband signal via connection 1410. In some examples, the digital transmitter 1402 may be configured to up-convert the baseband signal. For example, the digital transmitter 1402 may include a quadrature up-converter to apply to the baseband signal. In some examples, the digital transmitter 1402 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 1402.

In some examples, the transceiver 1416 may include one or more subcomponents that may be used in preparing the baseband signal and/or transmitting the baseband signal. For example, the transceiver 1416 may include an RF front end (e.g., in a wireless environment) which may include a power amplifier (PA), a digital transmitter (e.g., 1402), a digital front end, an institute of electrical and electronics engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 1404) of the transceiver 1416 may be synchronized with the resource controller via the S-plane device, which may contribute to high-accuracy timing with respect to a reference clock.

In some examples, the transceiver 1416 may be configured to obtain the baseband signal for transmission. For example, the transceiver 1416 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 1416 may be configured to generate a baseband signal for transmission. In these and other examples, the transceiver 1416 may be configured to transmit the baseband signal to another device, such as the device 1414.

In some examples, the device 1414 may be configured to receive a transmission from the transceiver 1416. For example, the transceiver 1416 may be configured to transmit a baseband signal to the device 1414.

In some examples, the radio frequency circuit 1404 may be configured to transmit the digital signal received from the digital transmitter 1402. In some examples, the radio frequency circuit 1404 may be configured to transmit the digital signal to the device 1414 and/or the digital receiver 1406. In some examples, the digital receiver 1406 may be configured to receive a digital signal from the RF circuit and/or send a digital signal to the processing device 1408.

In some examples, the processing device 1408 may be a standalone device or system, as illustrated. Alternatively, or additionally, the processing device 1408 may be a component of another device and/or system. For example, in some examples, the processing device 1408 may be included in the transceiver 1416. In instances in which the processing device 1408 is a standalone device or system, the processing device 1408 may be configured to communicate with additional devices and/or systems remote from the processing device 1408, such as the transceiver 1416 and/or the device 1414. For example, the processing device 1408 may be configured to send and/or receive transmissions from the transceiver 1416 and/or the device 1414. In some examples, the processing device 1408 may be combined with other elements of the communication system 1400.

FIG. 15 illustrates a diagrammatic representation of a machine in the example form of a computing device 1500 within which a set of instructions, for causing the machine to perform any one or more of the methods discussed herein, may be executed. The computing system may be configured to implement or direct one or more operations associated with AP interference reduction. The computing device 1500 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1500 includes a processing device (e.g., a processor 1502), a main memory 1504 (e.g., read-only memory (ROM), flash memory, dynamic random access memory (DRAM) such as synchronous DRAM (SDRAM)), a static memory 1506 (e.g., flash memory, static random access memory (SRAM)) and a data storage device 1516, which communicate via a bus 1508.

Processing device (e.g., a processor 1502) represents one or more general-purpose processing devices such as a microprocessor, central processing unit, or the like. More particularly, the processing device (e.g., a processor 1502) may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device (e.g., a processor 1502) may also include one or more special-purpose processing devices such as an application specific integrated circuit (ASIC), a field programmable gate array (FPGA), a digital signal processor (DSP), network processor, or the like. The processing device (e.g., a processor 1502) may be configured to execute instructions 1526 for performing the operations and steps discussed herein.

The computing device 1500 may further include a network interface device 1522 which may communicate with a network 1518. The computing device 1500 also may include a display device 1510 (e.g., a liquid crystal display (LCD) or a cathode ray tube (CRT)), an alphanumeric input device 1512 (e.g., a keyboard), a cursor control device 1514 (e.g., a mouse) and a signal generation device 1520 (e.g., a speaker). In at least one example, the display device 1510, the alphanumeric input device 1512, and the cursor control device 1514 may be combined into a single component or device (e.g., an LCD touch screen).

The data storage device 1516 may include a computer-readable storage medium 1524 on which is stored one or more sets of instructions 1526 embodying any one or more of the methods or functions described herein. The instructions 1526 may also reside, completely or at least partially, within the main memory 1504 and/or within the processing device (e.g., a processor 1502) during execution thereof by the computing device 1500, the main memory 1504 and the processing device (e.g., a processor 1502) also constituting computer-readable media. The instructions may further be transmitted or received over a network 1518 via the network interface device 1522.

While the computer-readable storage medium 1524 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

### EXAMPLES

The following provide examples of the performance characteristics according to embodiments of the present disclosure.

### Example 1

### High-Interference and Low-Interference STA Locations

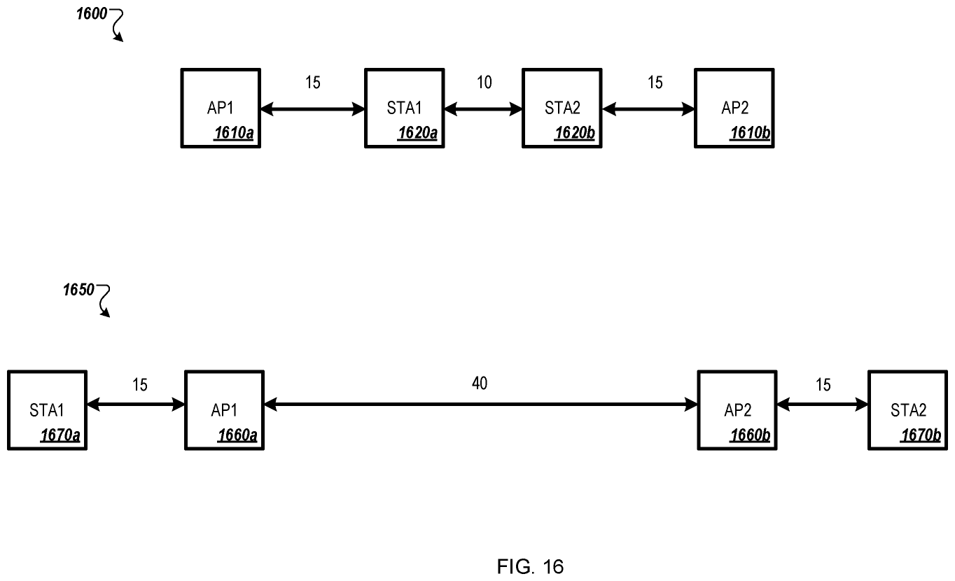

As illustrated in FIG. 16, a high-interference STA location scenario 1600 is illustrated and a low-interference STA location scenario 1650 is illustrated. For the high-interference STA location scenario 1600, AP1 1610a may be a location of 15 meters from STA1 1620a, which may be 10 meters from STA2 1620b, which may be 15 meters from AP2 1610b. For the low-interference STA location scenario 1650, STA1 1670a may be located 15 meters from AP1 1660a, which may be located 40 meters from AP2 1660b, which may be located 15 meters from STA2 1670b.

In the high-interference STA location scenario 1600 and the low-interference STA location scenario 1650, the transmit power may be selected to avoid interference to ongoing transmission and/or the MCS may be selected to optimize performance for a determined SINR.

### Example 2

### Simulation Details for High-Interference and Low-Interference STA Locations

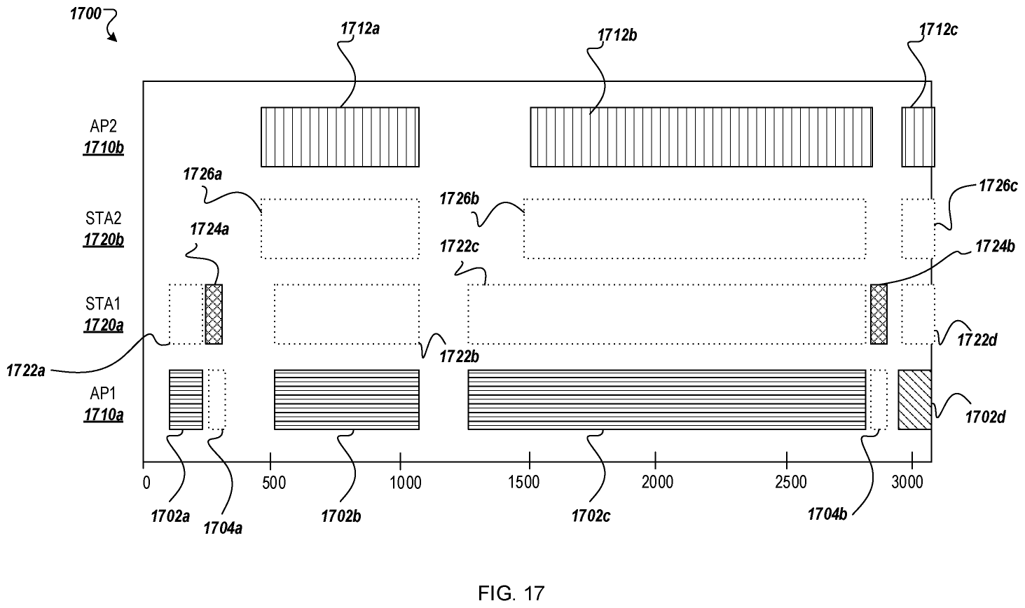

As illustrated in FIG. 17, a simulation 1700 may use discrete event simulation that may use transmission power back-off in which MCS may be selected as a function of SINR. For this simulation, the behavior, duration, and interference of actual packets was simulated. AP1 1710a may transmit in time windows 1702a, 1702b, 1702c, 1702d. During transmission time windows 1704a and 1704b, AP1 1710b may receive from STA 1 1720a. STA1 1720a may transmit to AP1 1710a during transmission time windows 1724a, 1724b. During transmission time windows 1722a, 1722b, 1722c, 1722d, STA1 1720a may receive from AP1 1710a. AP2 1710b may transmit during transmission time windows 1712a, 1712b, 1712c. STA2 1720b may receive from AP2 1710b during transmission time windows 1726a, 1726b, 1726c. The transmission results (e.g., success or failure) were generated by evaluating the SINR for each packet and determining how the MCS performed based on the particular SINR.

### Example 3

### Performance Results for High-Interference and Low-Interference STA Locations

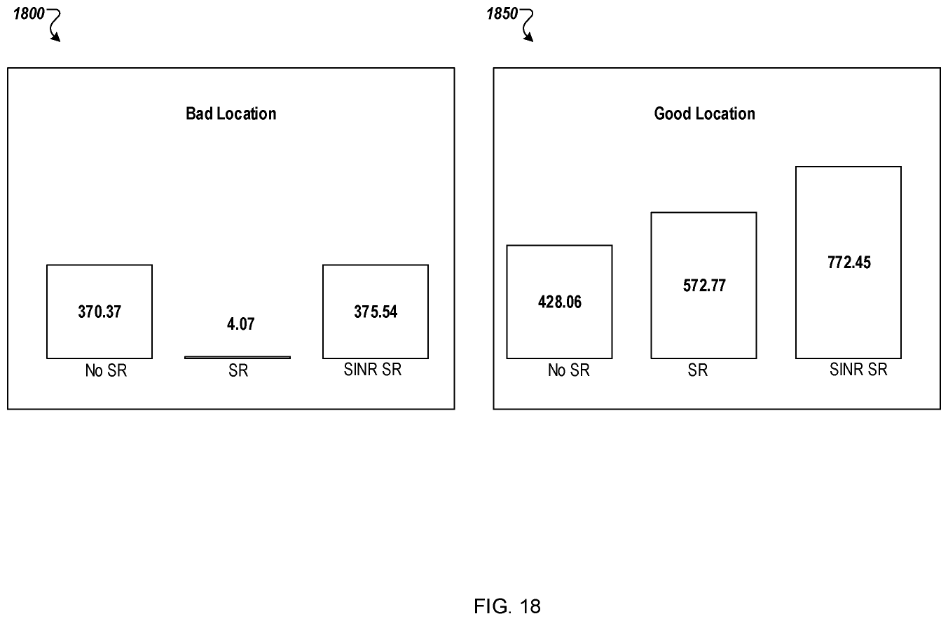

As illustrated in FIG. 18, the high-interference STA location performance results 1800 and the low-interference STA location performance results 1850 illustrated that spatial reuse enhanced performance for the low-interference STA location scenario when compared to the high-interference STA location scenario.

For the high-interference STA location performance results 1800, when spatial reuse was not used, the performance was 370.37 Mbps. For the high-interference STA location performance results 1800, when spatial reuse was used, the performance was 4.07 Mbps. For the high-interference STA location performance results 1800, when SINR-aware spatial reuse was used, the performance was 375.54 Mbps. Therefore, for the bad location scenarios, when spatial reuse was applied without using the SINR, the performance was degraded relative to a scenario in which SINR-aware spatial reuse was used.

For the low-interference STA location performance results 1850, when spatial reuse was not used, the performance was 428.06 Mbps. For the low-interference STA location performance results 1850, when spatial reuse was used, the performance was 572.77 Mbps. For the low-interference STA location performance results 1850, when SINR-aware spatial reuse was used, the performance was 772.45 Mbps. Therefore, when SINR-aware spatial reuse was used, the performance for the good location scenario was enhanced relative to a scenario in which spatial reuse was used without using SINR.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the disclosure and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A system for wireless communication, the system comprising:
data processing hardware; and
memory hardware in communication with the data processing hardware, the memory hardware storing instructions that when executed on the data processing hardware cause the data processing hardware to perform operations comprising:
receiving, at a second access point (AP) from a first AP, an identity of a first receiving station (STA) and a first predicted signal-to-interference-plus-noise ratio (SINR) at the first STA, wherein the first STA is operable to receive a transmission from the first AP and the first predicted SINR is computed when the second AP begins transmitting;
computing, at the second AP, a second predicted SINR at a second STA when the first AP begins transmitting;
computing, at the second AP, a first transmit power back-off based on the first predicted SINR and the second predicted SINR; and
determining, at the second AP, one or more transmission parameters based on the first transmit power back-off.

2. The system of claim 1, further comprising instructions that cause the data processing hardware to perform operations comprising:
initializing, at the second AP, a spatial reuse transmission opportunity (SR TXOP); and
generating, at the second AP, a spatial reuse (SR) transmission for transmission to the second STA.

3. The system of claim 1, further comprising instructions that cause the data processing hardware to perform operations comprising:
identifying, at the second AP, an identity of a second STA and a second predicted SINR at the second STA, wherein the second STA is operable to receive a transmission from the second AP; and
sending, from the second AP to the first AP, the identity of the second STA and the second predicted SINR.

4. The system of claim 1, further comprising instructions that cause the data processing hardware to perform operations comprising:
sending, from the second AP to the first AP, a joint training transmission time;
sending, from the second AP to the second STA, the joint training transmission time to compute the second predicted SINR; and
receiving, at the second AP from the second STA, the second predicted SINR.

5. The system of claim 1, further comprising instructions that cause the data processing hardware to perform operations comprising:
terminating, at the second AP, a spatial reuse transmission to match a transmission end of the transmission from the first AP.

6. The system of claim 1, further comprising instructions that cause the data processing hardware to perform operations comprising:
identify, at the second AP, a spatial reuse transmission failure; and
perform, at the second AP:
a subsequent channel access without using spatial reuse, or
adapt a spatial reuse rate to avoid interference with the first AP.

7. The system of claim 1, further comprising instructions that cause the data processing hardware to perform operations comprising:
determining, at the second AP, the first transmit power back-off based on one or more of background noise or a maximum receive error vector magnitude (EVM).

8. The system of claim 1, wherein the one or more transmission parameters include one or more of a modulation and coding scheme (MCS), a transmission (Tx) power, or bandwidth.

9. A method for spatial reuse, comprising:
identifying, at a first access point (AP), a training transmission time, wherein the first AP is operable to transmit a first training transmission during the training transmission time and a second AP is operable to transmit a second training transmission during the training transmission time;
computing, at a first AP during the training transmission time, a first signal-to-interference-plus noise ratio (SINR) between the first AP and a first receiving station (STA);
receiving, at a first AP from the second AP, a second SINR between the second AP and a second receiving STA; and
computing, at the first AP, a first transmit power back-off;
receiving, at the first AP from the second AP, a second transmit power back-off; and
computing, at the first AP, one or more first transmission parameters based on the first transmit power back-off and the second transmit power back-off.

10. The method of claim 9, further comprising:
receiving, at the first AP from the second AP, one or more second transmission parameters based on the first transmit power back-off and the second transmit power back-off

11. The method of claim 9, further comprising
initializing, at the first AP, a transmission opportunity (TXOP); and
generating, at the first AP, a transmission to the first STA.

12. The method of claim 9, further comprising:
determining, at the first AP, the one or more first transmission parameters based on a weighted average of the first SINR and the second SINR.

13. The method of claim 9, further comprising:
terminating, at the second AP, a spatial reuse transmission to match a transmission end of a transmission from the first AP.

14. The method of claim 9, further comprising:
determining, at the first AP, the first transmit power back-off based on one or more of background noise or a maximum receive error vector magnitude (EVM).

15. The method of claim 9, wherein the one or more first transmission parameters include one or more of a modulation and coding scheme (MCS), a transmission (Tx) power, or a bandwidth.

16. A system for wireless communication, the system comprising:
data processing hardware; and
memory hardware in communication with the data processing hardware, the memory hardware storing instructions that when executed on the data processing hardware cause the data processing hardware to perform operations comprising:
receiving, at a second access point (AP) from a first AP, an identity of a first receiving station (STA) operable to receive a transmission from the first AP and a predicted signal-to-noise ratio (SNR) at the first STA;
computing, at the second AP, a first predicted signal-to-interference-plus-noise ratio (SINR) at the first STA when the second AP begins transmitting; and
computing, at the second AP, a transmit power back-off based on the predicted SNR and the first predicted SINR.

17. The system of claim 16, further comprising instructions that cause the data processing hardware to perform operations comprising:
initializing, at the second AP, a spatial reuse transmission opportunity (SR TXOP); and
generating, at the second AP, a spatial reuse (SR) transmission for transmission to a second STA.

18. The system of claim 16, further comprising instructions that cause the data processing hardware to perform operations comprising:
determining, at the second AP, one or more transmission parameters to match a second predicted SINR at a second STA when the first AP is transmitting.

19. The system of claim 18, wherein the one or more transmission parameters include one or more of a modulation and coding scheme, a transmission (Tx) power, or a bandwidth.

20. The system of claim 16, further comprising instructions that cause the data processing hardware to perform operations comprising:
computing, at the second AP, a path loss between the second AP and the first STA; and
computing, at the second AP, the transmit power back-off based on the path loss.

21. The system of claim 16, further comprising instructions that cause the data processing hardware to perform operations comprising:
computing, at the second AP, a transmit power back-off based on a ratio between the predicted SNR and the first predicted SINR.
